(19) United States
(12) Patent Application Publication
(10) Pub. No.: US 2024/0025148 A1
(43) Pub. Date: Jan. 25, 2024

(54) LAYERED COMPOSITE

(71) Applicant: Heraeus Deutschland GmbH & Co. KG, HANAU (DE)

(72) Inventors: Markus SCHEIBEL, Hanau (DE); Anton-Zoran MIRIC, Hanau (DE); Tamara ALBERT, Hanau (DE)

(21) Appl. No.: 18/044,155

(22) PCT Filed: Sep. 1, 2021
(86) PCT No.: PCT/EP2021/074068

§ 371 Date: Mar. 6, 2023

(30) Foreign Application Priority Data
Sep. 11, 2020 (EP) 20195642.2

(51) Int. Cl. B32B 13/06; B32B 15/20; B32B 13/02; B32B 37/15

(52) U.S. Cl. CPC B32B 13/06; B32B 15/20; B32B 13/02; B32B 37/15; B32B 2307/7376; B32B 2457/00; B32B 2311/12; B32B 2315/06; B32B 2250/42; B32B 2264/1021; B32B 2264/1023; B32B 2309/02

(57) ABSTRACT

Laminar structure comprising two outwardly facing metal layers with an interposed alternating layer sequence made up of n layers of a hydraulically cured inorganic cement composition and n−1 metal layers, where n=1, 2, or 3.

The invention relates to a layered composite (laminar structure) comprising two outwardly facing metal layers and at least one intermediate layer made of a hydraulically cured inorganic cement composition, a method for the production of said structure, and its use.

The term “hydraulic curing” used herein means setting in the presence of water or after the addition of water.

Substrates that are usable as circuit carriers are known in the field of electronics. Examples of such substrates include: lead frames; PCBs (printed circuit boards); ceramic substrates; metal ceramic substrates such as DCB (direct copper bonded), AMB (active metal coated) or IMS substrates (isolated metal substrates); and the like.

The present invention consists in providing a new substrate type which, in its basic design, can be most closely compared to a metal ceramic substrate.

The new substrate type according to the invention is a laminar structure comprising or consisting of two outwardly facing metal layers with an interposed alternating layer sequence made up of n layers of a hydraulically cured inorganic cement composition and n−1 metal layers, where n=1 (laminar structure of type I), 2 (laminar structure of type II), or 3 (laminar structure of type III).

The layer sequence in the laminar structure of the preferred type I is: “outer metal layer/layer or intermediate layer made of a hydraulically cured inorganic cement composition/outer metal layer”.

The layer sequence in the laminar structure of type II is: “outer metal layer/layer made of a hydraulically cured inorganic cement composition/metal layer/layer made of a hydraulically cured inorganic cement composition/outer metal layer”.

The layer sequence in the laminar structure of type III is: “outer metal layer/layer made of a hydraulically cured inorganic cement composition/metal layer/layer made of a hydraulically cured inorganic cement composition/metal layer/layer made of a hydraulically cured inorganic cement composition/outer metal layer”.

A distinction is made herein between hydraulically curable inorganic cement, aqueous hydraulically curable inorganic cement preparation, and hydraulically cured inorganic cement composition. By mixing with water, an aqueous hydraulically curable inorganic cement preparation may be produced from hydraulically curable inorganic cement which is present in powder form, which preparation is in particular in the form of a viscoelastic, for example paste-like or flowable mass, also referred to as “cement paste” or “cement glue”. An aqueous hydraulically curable inorganic cement preparation may, in turn, cure hydraulically to form a hydraulically cured inorganic cement composition in the form of a hard solid, also referred to as “cement stone”. Such a hydraulically cured inorganic cement composition is practically water-insoluble, i.e. substantially or completely water-insoluble.

The laminar structure according to the invention is substantially or completely flat. “Substantially flat” means that the laminar structure according to the invention may exhibit a tolerable and inherently unwanted warpage, for example of no more than up to 1000 μm. Such a warpage can occur due to different thermal expansion characteristics of the different layers.

Unless expressly noted otherwise, the further description takes place using the example of the preferred embodiment of the laminar structure of type I according to the invention. For the laminar structures of type II or III according to the invention, the same applies both with regard to the laminar structures per se and with respect to their production and use.

The laminar structure of type I according to the invention is present in the form of a sandwich arrangement, with the two metal layers arranged parallel to one another and separated from one another by the layer made of the hydraulically cured inorganic cement composition.

When the laminar structure of type I according to the invention is viewed in the horizontal position, one of the two metal layers forms the upper side of the laminar structure and the other forms the underside. In order to preclude misunderstandings, with regard to a possible use as a substrate in electronics, the upper side is understood as the side intended for bearing the actual electronic circuit (the side on which the electronic components are fastened); the underside, by contrast, is used to dissipate heat arising as a result of power loss during operation of the electronic circuit and also remains reserved for this function; for example, it can be connected to a heat sink, which is conventional in the field of electronics, or to a base plate in a materially bonded manner (for example by a heat-conducting adhesive joint, sintered joint, or soldered joint). It is also possible to form the metal layer of the underside directly as a heat sink or to replace it with such a heat sink.

In the case of electrical connection to the upper-side metal layer, the internal metal layers of the alternating layer sequence to be found in the laminar structures of type II and III may be used for current conduction which minimizes electrical losses. Electrical connections between metal layers may be realized by means of electrically conductive spacers (also referred to as vias) which are mentioned in the following.

The total thickness of the laminar structure of type I according to the invention is formed from the sum of the individual layer thicknesses of the two metal layers and the thickness of the layer made of the hydraulically cured inorganic cement composition, and, if present, the layer thickness contributions of one or more additional optional layers; in the case of laminar structures of type II or III according to the invention, layer thickness contributions of internal metal layers and corresponding hydraulically cured inorganic cement composition layers are added. Optional layers are different from metal layers and also from layers of hydraulically cured inorganic cement composition. The layer thickness of the metal layer forming the upper side, as well as of the internal metal layers, is, for example, in the range of from 100 to 1500 μm, whereas the layer thickness of the metal layer forming the underside may, for example, be in the range of from 100 to 1500 μm or optionally even greater, for example up to 5000 μm. The layer thicknesses of the metal layers may all be the same, partially the same, or all different from one another. Particularly high layer thicknesses of the underside may occur when the underside itself forms a base plate. The layer thickness of hydraulically cured inorganic cement composition layers is in each case in the range of 50 to 1000 μm, for example. The metal layers can in each case be formed from conventional metal foils, as will be explained in further detail in the following. In other words, the thickness of the metal layers corresponds to that of such metal foils.

As will be explained subsequently, a laminar structure according to the invention may be produced by means of a continuous or discontinuous method. The format (contour and surface measure) of a discontinuously produced laminar structure according to the invention may vary within wide ranges. The surface measure is generally in the range of from 2 to 700 cm². In general, the laminar structures are in rectangular form, for example in the format of 1 cm by 2 cm to 14 cm by 50 cm.

In the case of a laminar structure according to the invention that can be used directly as a substrate in the field of electronics, the surface measure is more in the lower region of the value range mentioned by way of example; for example, it may be in the range of from 2 to 100 cm², preferably in rectangular form.

However, the laminar structure according to the invention may also be designed as a large-area source for a plurality of small-area laminar structures according to the invention that can be used directly as a substrate in the field of electronics, for example comparable to a master card which is known from the field of metal ceramic substrates and can be divided into a plurality of smaller substrates of the desired format. The surface measure is then more in the upper region of the aforementioned value range.

The edges of the metal layers do not project beyond the edges of the layer or layers of hydraulically cured inorganic cement composition; they either terminate jointly therewith, or the layer(s) of hydraulically cured inorganic cement composition has/have a slightly larger surface area than the metal layers and is/are not covered by the metal layers in the entire edge region thereof in such a way that a small projection of hydraulically cured inorganic cement composition, for example 0.2 to 3 mm wide, is present without metal layer coverage. The metal layers may have an edge reduction of their edges, i.e. they may have an outwardly progressing layer thickness reduction in the edge region. The metal layers are generally arranged congruently, i.e. in the same format and not displaced relative to one another.

The metal layers may consist of the same or different metals. Especially copper and copper alloys, molybdenum and molybdenum alloys, and aluminum and aluminum alloys can be mentioned as examples of suitable metals. Copper alloys, molybdenum alloys, and aluminum alloys generally comprise at least 90 wt. % copper, at least 90 wt. % molybdenum, or at least 90 wt. % aluminum.

The intermediate layer of the laminar structure of type I according to the invention or the layers between the metal layers of the laminar structures of type II and III according to the invention consist of a hydraulically cured inorganic cement composition. In the case of the laminar structures of type II and III according to the invention with their two or three hydraulically cured inorganic cement composition layers, the latter may consist of hydraulically cured inorganic cement compositions that are the same or differ from one another.

The hydraulically cured inorganic cement composition(s) may consist of a hydraulically cured inorganic cement or, in addition to the actual hydraulically cured inorganic cement, i.e. in addition to the hydraulically cured inorganic cement forming a matrix, may comprise one or more further constituents, for example in a total proportion of 0.5 to 98 wt. %. In both instances, the hydraulically cured inorganic cement composition can be formed in particular by mixing hydraulically curable inorganic cement plus optionally the at least one further constituent with water to form an aqueous hydraulically curable inorganic cement preparation, application thereof, followed by its hydraulic curing (i.e. setting) and drying.

The aqueous hydraulically curable inorganic cement preparation may contain a water content of, for example, 6 to 25 wt. %.

The viscosity of a freshly prepared (within 5 minutes after finishing), aqueous hydraulically curable inorganic cement preparation may, for example, be in the range of from 0.5 to 20 Pas (in the case of determination by means of rotary viscometry, plate-plate measurement principle, plate diameter 25 mm, measuring gap 1 mm, sample temperature 20° C.).

If the hydraulically cured inorganic cement composition comprises, in addition to the actual hydraulically cured inorganic cement, one or more further constituents, the aqueous hydraulically curable inorganic cement preparation also comprises one or more further constituents, in particular the same constituent or constituents, in addition to the actual hydraulically curable inorganic cement and water. Such further constituents may already be added or admixed to the hydraulically curable inorganic cement. It is also possible to first mix the hydraulically curable inorganic cement with all of the further constituents without addition of water, and then with water to form the aqueous hydraulically curable inorganic cement preparation. However, it is also possible to work in such a way that the further constituent or constituents is/are added separately before, during, and/or after the addition of water. The quantitative proportion and the time of addition or the order of addition are in accordance with the relevant chemical and physical properties during the production of the aqueous hydraulically curable inorganic cement preparation with regard to its homogeneity and manageability; from a practical point of view, a person skilled in the art in this case in particular orients themselves by the mixing behavior and processing behavior, for example what is known as the pot life.

The aforementioned further constituent or constituents may be included in a total proportion of, for example, 0.1 to 92 wt. %, relative to the aqueous hydraulically curable inorganic cement preparation.

The hydraulically curable inorganic cement is, per se, a pourable powder. This may be, for example, a Portland cement, aluminous cement, magnesium oxide cement, phosphate cement, for example zinc phosphate cement or preferably magnesium phosphate cement, which is known to a person skilled in the art.

The particles contained in the hydraulically curable inorganic cement, and also possible further constituents in particulate form, have particle sizes below the layer thickness of the hydraulically cured inorganic cement composition.

Examples of aforementioned further constituents include fillers, fibers, flow improvers, setting retardants (pot life extenders), defoamers, water-miscible organic solvents, hydrophobizing agents, additives which influence surface tension, wetting agents, and adhesion promoters.

Examples of fillers include glass; calcium sulfate; barium sulfate; simple and complex silicates comprising sodium, potassium, calcium, aluminum, magnesium, iron, and/or zirconium; simple and complex aluminates comprising calcium, magnesium, and/or zirconium; simple and complex titanates comprising calcium, aluminum, magnesium, barium, and/or zirconium; simple and complex zirconates comprising calcium, aluminum, and/or magnesium; zirconium dioxide; titanium dioxide; aluminum oxide; silicon dioxide, in particular in the form of silica and quartz; silicon carbide; aluminum nitride; boron nitride; and silicon nitride. A distinction is made herein between simple and complex silicates, aluminates, titanates and zirconates. The complex representatives are not, for instance, complex compounds; rather, what is intended therewith are silicates, aluminates, titanates and zirconates with more than one type of cations, for example sodium aluminum silicate, calcium aluminum silicate, lead zirconate titanate etc. The presence of such fillers may have an advantageous effect on the thermal conductivity and/or the thermal expansion behavior of the hydraulically cured inorganic cement composition.

Examples of fibers include glass fibers, basalt fibers, boron fibers, and ceramic fibers, for example silicon carbide fibers and aluminum oxide fibers, rock wool fibers, wollastonite fibers, and aramid fibers. The presence of fibers may have an advantageous effect on the tensile stress resistance and the thermal shock resistance of the hydraulically cured inorganic cement composition.

The laminar structure of type I according to the invention may be produced by applying the aforementioned aqueous hydraulically curable inorganic cement preparation in a homogeneous layer thickness between two metal foils, followed by hydraulic curing and drying of the applied aqueous hydraulically curable inorganic cement preparation. The laminar structures of type II and III according to the invention may be produced very analogously by applying identical or different aqueous hydraulically curable inorganic cement preparations in a homogeneous layer thickness between three or four metal foils in each case, followed by hydraulic curing and drying of the applied aqueous hydraulically curable inorganic cement preparation. The invention in this respect also relates to production methods for the laminar structures according to the invention. Possible production methods may be continuous or discontinuous. Various application methods are possible, for example printing, blade coating, spraying, dispensing, brushing, or pouring, the latter with or without vacuum assistance. The hydraulic curing or the setting may occur under ambient conditions, for example at an ambient temperature in the range of from 20 to 25° C., and thereby require a duration of, for example, 1 minute to 6 hours. If the setting duration is to be shortened, it is possible to work at an elevated temperature; for example, the setting may take place at an object temperature of 30 to below 100° C., and it is then already finished within a few seconds to 1 hour, for example. The drying, which is used for dehydration, is followed by setting and requires, for example, 0.5 to 6 hours at an object temperature of 80 to 600° C., it possibly being expedient to pass through a plurality of temperature stages. The drying may take place in a vacuum-assisted manner.

In an embodiment designed as a discontinuous method, the production method for a laminar structure of type I according to the invention may comprise the steps of:
(1) providing a mold which defines the format of the laminar structure according to the invention, and an aqueous hydraulically curable inorganic cement preparation produced as previously mentioned,
(2) pre-laying a metal foil into the mold,
(3) applying the aqueous hydraulically curable inorganic cement preparation to the pre-laid metal foil,
(4) applying a further metal foil to the applied aqueous hydraulically curable inorganic cement preparation, and
(5) hydraulic curing and drying of the aqueous hydraulically curable inorganic cement preparation,
   steps (2) to (4) being implemented such that a laminar structure comprising the outwardly facing metal foils is formed with an interposed layer of the aqueous hydraulically curable inorganic cement preparation. The corresponding discontinuous production method for a laminar structure of type II or III according to the invention is analogous, steps (3) and (4) being repeated accordingly.

In step (1), a mold which defines the format of the laminar structure according to the invention is provided. The mold allows for the accommodation of the metal foils to be received in steps (2) and (4), as well as of the aqueous hydraulically curable inorganic cement preparation to be received between the metal foils in step (3). Furthermore, in step (1), the aqueous hydraulically curable inorganic cement preparation to be applied in step (2) is provided. The production of said preparation may take place as mentioned above.

In step (2), a metal foil is placed into the mold provided in step (1).

Spacers may be applied between step (2) and step (3). The spacers may be particularly thermally conductive. The spacers may help define the distance between the metal layers or the layer thickness of the intermediate layer made of aqueous hydraulically curable inorganic cement preparation or the hydraulically cured inorganic cement composition produced therefrom. The spacers may also function as particularly effective heat conducting paths within the intermediate layer, from the upper-side metal layer to the lower-side metal layer. In the case of a laminar structure of type II or III according to the invention, spacers may be electrically conductive.

In step (3), the aqueous hydraulically curable inorganic cement preparation provided in step (1) is applied to the metal foil placed in the mold. Various application methods are possible, for example printing, blade coating, spraying, dispensing, brushing, or pouring, the latter with or without vacuum assistance. The amount arriving for application is in accordance with the desired layer thickness of the intermediate layer made of the hydraulically cured inorganic cement composition that is to be formed. During the execution of step (3), the person skilled in the art understands to take into account a possible volume change, for example volume shrinkage behavior, of the material during step (5); in other words, they will select the wet layer thickness accordingly.

In step (4), the second metal foil is applied or placed on the applied aqueous hydraulically curable inorganic cement preparation. In the implementation of step (4), it may be expedient to take assistive measures, such as the action of vibration, ultrasound, or pressing force, for example by means of a stamp or a weight.

Steps (2) to (4) are implemented such that a laminar structure comprising the outwardly facing metal foils is formed with an interposed layer of the aqueous hydraulically curable inorganic cement preparation. In this case, it is expedient to ensure that the metal foils are flat and are not intentionally altered or damaged in this regard.

In step (5), the aqueous hydraulically curable inorganic cement preparation located between the metal foils is hydraulically cured and dried. This results in a laminar structure according to the invention. At least the setting takes place in the mold. The drying step may occur in and/or outside of the mold. The setting may take place under ambient conditions, for example at an ambient temperature in the range of from 20 to 25° C., and thereby require a duration of, for example, 1 minute to 6 hours. If the setting duration is to be shortened, it is possible to work at an elevated temperature; for example, the setting may take place at an object temperature of 30 to below 100° C., and it is then already finished within a few seconds to 1 hour, for example. The drying, which is used for dehydration, is followed by setting and requires, for example, 0.5 to 6 hours at an object temperature of 80 to 600° C., it possibly being expedient to pass through a plurality of temperature stages. The drying may take place in a vacuum-assisted manner.

Steps (1) to (5) represent a step sequence. Optionally, however, intermediate steps and/or steps subsequent to step (5) may take place. An example of such an intermediate step is the aforementioned spacer application. Another example is to provide a metal foil or the metal foils with an adhesion promoter on the side facing toward the aqueous hydraulically curable cement preparation, prior to executing steps (2) or (4). It is thus also possible, for example, to form the aforementioned further optional layers. The adhesion promoter entering into the laminar structure in this way may also partially or completely enter into the intermediate layer, for example by diffusion.

In an embodiment designed as a continuous method, the production method for a laminar structure according to the invention may take place in the context of a lamination, in which the metal layers are laminated with aqueous hydraulically curable cement preparation without using a format-defining mold and are subsequently supplied as a laminate to the hydraulic curing and drying processes.

A laminar structure according to the invention either already has a format desired for a specific application, for example desired in the field of electronics, or, as previously mentioned, it may be divided into smaller desired formats by conventional methods, for example by laser cutting or sawing.

The metal upper side of a laminar structure according to the invention may be machined and structured using methods as are conventional in the field of metal ceramic substrates; for example, relevant portions of the metal layer forming the upper side can be photolithographically masked and removed by etching.

As already mentioned above, a laminar structure according to the invention may be used as a substrate in the field of electronics; in this respect, a laminar structure according to the invention is an electronics substrate or an electronics substrate in the form of a laminar structure according to the invention. The metal layer forming the upper side may thus be used to connect to electronic components. The intermediate layer(s) of hydraulically cured inorganic cement composition is/are used as an insulator between the metal layers, and it/they may be used as a thermal bridge which establishes the thermal path to the metal layer forming the underside and to one or more heat sinks possibly connected thereto.

### EMBODIMENTS

Example 1: 7 parts by weight of an aluminous cement powder having a maximum particle size of 63 μm (oversize material 5%), 6 parts by weight of 2-imidazolidinone, 10 parts by weight of microsilica having a maximum particle size of 5 μm, 65 parts by weight of aluminum oxide powder having a maximum particle size of 100 μm, and 12 parts by weight of water were mixed to form an aqueous cement preparation. The aqueous cement preparation was applied by means of a brush to one side of a 0.5 mm thick copper foil (format 5 cm by 3 cm) in a homogeneous layer thickness of 760 μm. Subsequently, a second identical copper foil was placed congruently with the first copper foil on the side coated with the applied cement preparation and cured hydraulically at 20° C. for 4 hours. Subsequently, the sandwich arrangement provided in this way was heated at a heating rate of 1 K/min in an oven to 90° C. and held at this temperature for one hour. Thereafter, the temperature was increased to 160° C. at a heating rate of 1 K/min and held for one hour.

Example 2: 5 parts by weight of a magnesium oxide cement powder having a maximum particle size of 50 μm, 6 parts by weight of 2-imidazolidinone, 11 parts by weight of microsilica having a maximum particle size of 5 μm, 65 parts by weight of aluminum oxide powder having a maximum particle size of 100 μm, and 12 parts by weight of water were mixed to form an aqueous cement preparation. The aqueous cement preparation was applied by means of a brush to one side of a 0.5 mm thick copper foil (format 5 cm by 3 cm) in a homogeneous layer thickness of 760 μm. Subsequently, a second identical copper foil was placed congruently with the first copper foil on the side coated with the applied cement preparation and cured hydraulically at 20° C. for 4 hours. Subsequently, the sandwich arrangement provided in this way was heated at a heating rate of 1 K/min in an oven to 90° C. and held at this temperature for one hour. Thereafter, the temperature was increased to 160° C. at a heating rate of 1 K/min and held for one hour.

1. A laminar structure comprising or consisting of two outwardly facing metal layers with an interposed alternating layer sequence made up of n layers of a hydraulically cured inorganic cement composition and n−1 metal layers, where n=1, 2, or 3.

2. The laminar structure according to claim 1, wherein the layer thickness of the metal layers is in each case within the range of 100 to 1500 μm.

3. The laminar structure according to claim 1, wherein the layer thickness of the metal layers, with the exception of the metal layer forming the underside, is in each case within the range of 100 to 1500 μm, and wherein the layer thickness of the metal layer forming the underside is in the range of >1500 to 5000 μm.

4. The laminar structure according to claim 1, having a surface measure in the range of 2 to 700 cm².

5. The laminar structure according to claim 1, in a rectangular format.

6. The laminar structure according to claim 1, which either can be used directly as a substrate in the field of electronics or is designed as a large-area source for a plurality of small-area laminar structures which can be used directly as a substrate in the field of electronics.

7. The laminar structure according to claim 1, wherein the edges of the metal layers do not project beyond the edges of the layer or layers of hydraulically cured inorganic cement composition.

8. The laminar structure according to claim 1, wherein the metal layers are arranged congruently.

9. The laminar structure according to claim 1, wherein the metal layers consist of the same or different metals.

10. The laminar structure according to claim 1, wherein the metals of the metal layers are selected from the group consisting of copper, copper alloys, molybdenum, molybdenum alloys, aluminum, and aluminum alloys.

11. The laminar structure according to claim 1, wherein n=2 or 3 and the layers of hydraulically cured inorganic cement composition consist of hydraulically cured inorganic cement compositions that are the same or different from one another in each case.

12. The laminar structure according to claim 1, wherein the at least one hydraulically cured inorganic cement composition consists of a hydraulically cured inorganic cement or, in addition to the actual hydraulically cured inorganic cement, comprises one or more further constituents in a total proportion of 0.5 to 98 wt. %.

13. The laminar structure according to claim 12, wherein the hydraulically cured cement has been formed by hydraulic curing of a hydraulically curable inorganic cement selected from the group consisting of Portland cement, aluminous cement, magnesium oxide cement, and phosphate cement.

14. The laminar structure according to claim 1, wherein the further constituent or constituents is/are selected from the group consisting of fillers, fibers, flow improvers, setting retardants, defoamers, water-miscible organic solvents, hydrophobizing agents, additives which influence surface tension, wetting agents, and adhesion promoters.

15. A continuous or discontinuous method for producing a laminar structure according to claim 1, comprising the application of an aqueous hydraulically curable inorganic cement preparation in a homogeneous layer thickness in each case between metal foils, followed by hydraulic curing and drying of the applied aqueous hydraulically curable inorganic cement preparation.

16. The use of a laminar structure according to claim 1 or produced according to the application of an aqueous hydraulically curable inorganic cement preparation in a homogeneous layer thickness in each case between metal foils, followed by hydraulic curing and drying of the applied aqueous hydraulically curable inorganic cement preparation.
